(19) United States
(12) Patent Application Publication
(10) Pub. No.: US 2007/0104545 A1
(43) Pub. Date: May 10, 2007

(54) Tool for machining workpieces by chip removal

(75) Inventor: Klaus Matheis, Sauldorf/Rast (DE)

Correspondence Address: BURR & BROWN, PO BOX 7068, SYRACUSE, NY, 13261-7068, US

(73) Assignee: Joerg Guehring, Albstadt (DE)

(21) Appl. No.: 11/644,780

(22) Filed: Dec. 22, 2006

Related U.S. Application Data
(63) Continuation of application No. PCT/DE05/00535, filed on Mar. 24, 2005.

(30) Foreign Application Priority Data
Jun. 25, 2004 (DE) 20 2004 010 075.4

(51) Int. Cl. B26D 1/12

(52) U.S. Cl. 407/46

(57) ABSTRACT

The invention relates to a tool for machining workpieces by chip removal. A base body which rotates during the machining of the workpiece is provided with cartridges that are screwed thereto. According to the invention, the screwing means are arranged on the base body of the tool in such a way that they are supported thereon by means of anchoring means comprising a bearing surface, enabling a favourable force distribution to be obtained during the fixing of the cartridges.

### CROSS-REFERENCE TO RELATED APPLICATIONS

This application is a Continuation of International Application PCT/DE2005/000535, filed Mar. 24, 2005, the entirety of which is incorporated herein by reference. This application claims the benefit of German Application 20 2004 010 075.4, filed Jun. 25, 2004, the entirety of which is incorporated herein by reference.

### FIELD OF THE INVENTION

This invention relates to a tool for machining workpieces by chip removal.

### BACKGROUND OF THE INVENTION

Tools for machining workpieces by chip removal, particularly milling heads, are regularly fitted with cutting means arranged in a distributed fashion around their circumference. The cutting means are often cutting plates of PCD (polycrystalline diamonds), hard metal or the like, which are secured to cartridges, which are in turn arranged in recesses on the milling head.

Under the high forces that are generated, particularly in industrial production, the connections between the cutting means and the base body of the tool are subjected to high loads, which may result in changes in position of the cutting means relative to the base body of the tool. Accompanying this deviation from predetermined positions, there is a corresponding machining inaccuracy.

The loads in the connections are generated on the one hand by high feed rates and tough or hard material to be machined, and on the other by the high speeds of the tools. Thus, a load of approximately one metric ton already acts on the connection between a cutting means cartridge and the base body of the tool at a speed of 30,000 rpm, due merely to centrifugal force.

### BRIEF SUMMARY OF THE INVENTION

The object of this invention is to improve reliability and increase machining accuracy for a tool of the type already described.

A tool for machining workpieces by chip removal according to the present invention is characterised in that the screwing means for securing the cutting means cartridges are supported on the base body of the tool with anchoring means comprising a bearing surface.

The advantage of this, in particular, is that compared to a fixing of the cutting means on the base body, a more favourable distribution of force in the fastening region of the screw connection to the base body of the tool can be achieved by means of a thread.

For this purpose, the screwing means are arranged radially in an advantageous fashion on the base body of the tool. Here, the anchoring means of the screwing means are preferably arranged radially on the inside relative to the position of the cartridge. The advantage of this is that comparatively simple embodiments of screwing means, e.g. screws with a region thickened in the manner of a head so that the screw head, forms the anchoring means interacting with the base body of the tool. This screw head can obviously be widened more advantageously by the use of further means enlarging the bearing region, e.g. shims and the like.

However, anchoring means, which have a region that is thickened in the manner of a head and is specially adapted to the bearing region of the base body of the tool, are also conceivable. The region of the screwing means thickened in the manner of a head may not necessarily have a cylindrical shape for this purpose; it may, for example, also be designed as a curved plate, the bearing region being shaped, for example, according to the radius of a parallax recess in the base body of the tool. This provides an optimum surface with almost uniformly distributed force components all round between the bearing regions of the screwing means and the base body of the tool.

Openings may be formed in the base body of the tool in the radial direction in which the openings are drilled holes in the simplest case.

In a modified embodiment, the radially aligned openings for the screwing means may be designed as open slots running in the axial direction in which the slots enable the screwing means to be inserted on the end face in the base body of the tool in the axial direction. This may at the same time also allow axial positioning of the cutting bodies.

The openings in the base body of the tool, formed in the manner of slots, for the screwing means, are advantageously designed so that tilting moments generated during operation of the tool have no detrimental effect on the positioning of the cutting means. For example, this can be achieved by a sufficiently long slot or by recesses in the base body of the tool, in which the region of the screwing means thickened in the manner of a head can have a countersunk arrangement. Bearing regions, which guarantee adequate supports against tilting moments that are generated and are designed with sufficiently large surfaces, are also conceivable.

The region of the screwing means provided with the thread may engage directly in a thread arranged on a cartridge and interact with it. However, it is also conceivable for a further screwing means to act on the thread, as in the case, for example, of an male thread, a nut or a further screw with a further bearing region, which is correspondingly antagonistic to the first bearing region and fixes the cartridge on the base tool body. This may be the case, for example, when the screwing means has a female thread.

For fixing the cartridge to the base body of the tool, a recess may be provided on the cartridge in which the recess provides access for operating the screwing means so that it is admitted in the cartridge without projecting from it.

In a special embodiment, provision may also be provided for the cartridges to comprise at least two parts. Each of the parts is displaceable, one against the other, on a displacement surface, preferably a plane of displacement. The parts are secured to the base body of the tool by screwing means in such a manner that when the screwing means are tightened, a force component acts on the at least two parts so that force components acting on the two cartridge parts in opposite directions are generated in the plane of displacement on both cartridge parts. The clamping means may, for this purpose, be designed, for example, as wedging means, which are displaced one against the other by means of their wedge surfaces lying in the plane of displacement and press against the wall of the recess.

This provides the advantage that the cartridge can be clamped to the base body in an even more stable manner than would be the case, for example, with an integral cartridge.

For this purpose, a stop surface is provided on at least one cartridge part, which surface, in the clamped condition of the clamping means, bears against a wall of a recess formed in the base body of the tool for the cartridge. In particular, the cutting means are arranged on at least one of these cartridge parts. The advantage of this, therefore, is that the cutting means can be positioned exactly and distinctly in the circumferential direction. The head of the screwing means can, in this case, be arranged essentially radially on the outside or inside.

In a further advantageous embodiment, the cross-section of the recesses for the cartridges can be reduced radially outwards in one direction. This provides a further wedge shape where the tip of the wedge is aligned radially outwards in the base body so that centrifugal forces generated result in the wedging of the cartridge in the base body of the tool and so that the wedging elements bear against the lateral walls of the recesses assigned to them at all times.

In principle, the screwing means have a spring action, particularly in their axial extension, whose longitudinal expansion can be predetermined as a function of the speed-dependent centrifugal forces. The cutting means may therefore be positioned taking into consideration the longitudinal expansion of the screwing means that takes place at the specified operating speed. This means that the cartridges bearing the cutting means can be pre-tensioned during assembly of the tool to such an extent that they provide the correct machining dimensions for machining the workpiece at the speed specified for the application.

### BRIEF DESCRIPTION OF THE DRAWINGS

An exemplary embodiment of the invention is explained further in the drawings, with an indication of further advantages and details.

FIG. 1 shows a section from a sectional representation through a tool for machining workpieces by chip removal, in which a cartridge bearing cutting means is secured to a base body of a tool by means of a screwing means;

FIG. 2 shows a larger section from the sectional representation on which FIG. 1 is based, in different planes, and

FIG. 3 shows an embodiment modified relative to FIG. 1.

### DETAILED DESCRIPTION OF THE INVENTION

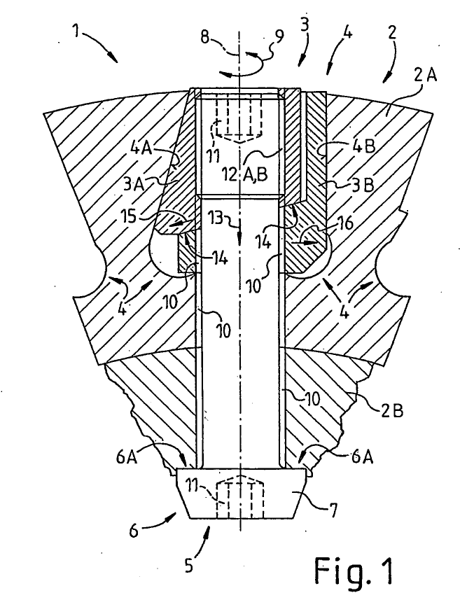

FIG. 1 shows, by way of example, a possible embodiment of this invention. Here, tool 1 includes a tool base body 2 in which a cartridge 3, including a cutting means, is arranged in a cartridge holder 4 provided for holding it and is fixed with a screwing means 5. Tool base body 2 consists of a tool base body part 2A arranged radially on the outside, on which part are formed cartridge holders 4 for cartridges 3, and of a second tool base body part 2B arranged radially on the inside, on which part screwing means 5 is supported with its bearing surface 6A formed on anchoring means 6 in the tightened condition of the screwing means. Here the bearing surface is formed on region 7 of screwing means 5 thickened in the manner of a head, and faces towards base body part 2B. Screwing means 5 may be rotated about screwing means axis 8 in both directions of rotation denoted by arrow 9 for fixing or releasing cartridge 3.

Screwing means 5 is rotated in recess 10 arranged in tool base body 2, and can be inserted by means of an actuating means, for example, a socket head 11. The socket head 11 shown by way of example may optionally be arranged on the end face of the screwing means in the radial internal and/or in the radial outer region of the tool base body.

By rotating about screwing means axis 8, thread 12 is correspondingly tightened or slackened. For this purpose a male thread is formed on screwing means 5 and a corresponding female thread is formed on cassette part 3A of cartridge 3.

When thread 12 is tightened, cartridge part 3A is pulled radially inwards in respect to tool base body 2, in the direction of arrow 13. Here it presses against displacement plane 14 at an angle to second cartridge part 3B that ranges between 90° and 180° in respect to screwing means axis 8. This angle gives rise to an oblique bearing surface in which displacement plane 14 lies and along which both cartridge parts 3A, 3B are displaced relative to each other under the fixing action of screwing means 5 so that they are pressed against the corresponding inner surfaces of cassette holders 4 with their outer surfaces running approximately perpendicular to the drawing plane and facing the lateral walls of cassette holder 4. The direction of movement of cartridge part 3A, when cartridge 3 is being fixed, is denoted by arrow 15, and the direction of movement of cartridge part 3B is denoted by arrow 16.

Screwing means 5 may in this exemplary embodiment be guided radially from the inside through recess 10 in tool base body 2 to the outside. Here it penetrates cartridge holder 4 with its threaded part after passing through tool base body part 2B and the bottom region of tool base body part 2A. It is then guided radially outwards through recess 10, which is also formed in cartridge part 3B, and finally engages in the male thread of cartridge part 3A until the fixing process described above has been completed.

Modified embodiments of this screwing means holder may be provided, for example, by a recess 10 designed in the form of a slot, the slot opening out on the end face of the tool, for example a milling head, so that the screwing means, if necessary together with both cartridge parts 3A, 3B, can be inserted in the milling head from the end face.

However, it is also conceivable for the slot to be designed as an orifice that closes through the circumference, i.e. access to recess 10 is only possible radially from the outside or from the inside. Head 7 of screwing means 5 may in such an exemplary embodiment be designed longitudinally, in which case both longitudinal sides lie so close to each other that head 7 can be inserted from the outside through slotted recess 10 into tool base body 2. After head 7 has arrived in a hollow region of tool base body 2 located radially inside tool base body part 2B, it can be rotated 90° so that a corresponding arrangement prevails, as can be seen in the representation in FIG. 1. Such an embodiment is conceivable particularly in tools with comparatively small outside diameters.

In order to improve the transmission of forces when fixing cartridges 3 by means of screwing means 5 in tool base body 2, tool base body part 2B may be produced from a material that is more resistant than tool base body part 2A. Consequently the forces transmitted via bearing surface 6A from screwing means 5 to tool base body part 2B may be absorbed even more effectively.

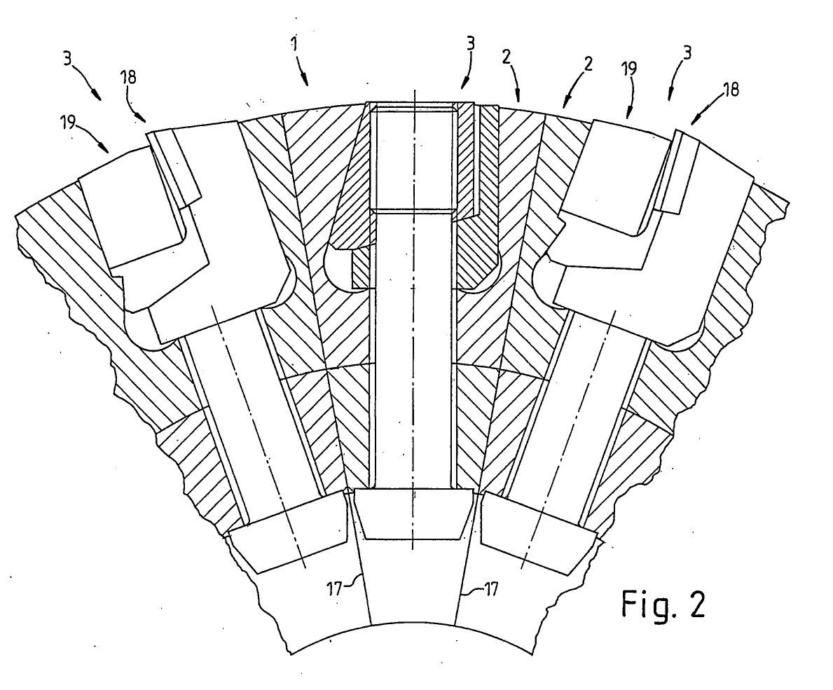

FIG. 2 shows the arrangement of a plurality of cartridges 3 on tool base body 2 by the cartridge fixing according to the invention. Here only the central cartridge is shown, with the associated screwing means 5 and region of tool base body 2 surrounding it, in a lower sectional plane. The remaining elements in FIG. 2 delimiting this region on the left and right at interfaces 17, are represented in an end face view of a milling head. The cutting means, for example in the form of PCD's, are denoted for this purpose by number 18 and the chip removal regions by numbers 19.

In this representation it can be clearly seen that tool 1 is fitted with a multiplicity of cartridges 3 on the circumference of tool base body 2. The radially internal region, which is formed about the longitudinal axis of the tool, i.e. the milling head, is in this case formed beyond part of its axial extension without material, in other words it is hollow.

Correspondingly, screwing means 5 may be inserted radially from the inside to the outside through recesses 10 in the manner described above. Cartridges 3 shown to the left and right of the central area of the figure, with associated screwing means 5, are arranged opposite in slotted recesses 10, the slots being open towards the end face of the tool so that a loose unit of cartridge parts 3A, 3B, screwed together, and screwing means 5 can be inserted on the end face in the milling head, then fixed.

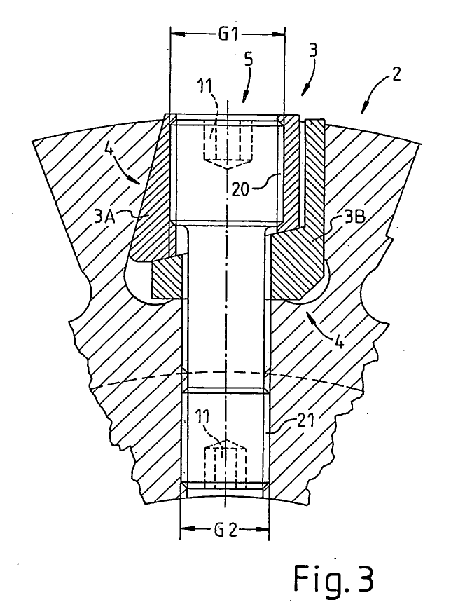

FIG. 3 shows a further embodiment of this invention in which screwing means 5 is designed as a threaded bolt with a differential thread. The differential thread consists of two thread sections 20, 21, which have different pitches. This produces a relative movement between cartridge 3 and tool base body 2 when screwing means 5, in the form of a threaded bolt, is screwed in, and cartridge 3 can be fixed radially on tool base body 2. Since the cartridge in this example is formed from at least two wedge-shaped parts 3A and 3B, the wedging effect already described above can be achieved in cartridge holder 4.

FIG. 3 shows screwing means 5 in the form of a threaded bolt with its larger outside diameter G1 in cartridge 3 and with its smaller diameter G3 engaging in tool base body 2. However, this arrangement is not necessarily required. Larger outside diameter G1 may also be arranged in the tool base body so that the threaded bolt is screwed in radially from the inside to the outside. The so-called “head region” of the threaded bolt is then arranged with its shape-dependent larger mass radially closer to the axis of rotation of tool 1. This is particularly advantageous in the case of tools with a larger outside diameter G1.

In these exemplary embodiments screwing means 5 may also be formed on tool base body 2 either so that they can be operated either from the inside and/or from the outside, for which see, by way of example, both socket heads 11.

1. A tool for machining workpieces by chip removal, comprising:
a tool base body which rotates during workpiece machining; and
a plurality of cartridges having cutting means secured to the tool base body by screwing means, supported on the tool base body with anchoring means having a bearing surface.

2. The tool according to claim 1 wherein the cartridges comprise at least two parts being displaceable relative to one another on a displacement surface, and being secured by the screwing means to the tool base body in such a manner that when the screwing means is tightened, a force component acts on the at least two cartridge parts so that in the displacement surface force components acting in opposite directions are generated on both cartridge parts.

3. The tool according to claim 1 wherein the screwing means are arranged radially on the tool base body.

4. The tool according to claim 1 wherein the anchoring means of the screwing means are arranged radially on the inside with respect to the position of the cartridge.

5. The tool according to claim 1, wherein the anchoring means comprise a region of the screwing means that is thickened in the manner of a head.

6. The tool according to claim 1, wherein the screwing means can be inserted in the tool base body in the radial direction.

7. The tool according to claim 1, wherein the screwing means can be inserted in the tool base body in the axial direction.

8. The tool according to claim 1, wherein the screwing means are accessible for their operation via a recess in the cartridge.

9. The tool according to claim 11, wherein the screwing means are designed as differential threaded bolts with two different threads.

10. The tool according to claim 1, wherein at least one cartridge part is provided with a stop surface which, when the screwing means are clamped, bears against a wall of a recess formed in the tool base body for each cartridge.

11. The tool according to claim 1, wherein the cross-section of the recesses for the cartridges is reduced in a radially outward direction.
